(19) United States
(12) Patent Application Publication
(10) Pub. No.: US 2024/0107568 A1
(43) Pub. Date: Mar. 28, 2024

(54) TECHNIQUES FOR CHANNEL SELECTION

(71) Applicant: QUALCOMM Incorporated, San Diego, CA (US)

(72) Inventors: Venkateswara Swamy Bandaru, Bangalore (IN); Krishna Chaitanya Rao, Bangalore (IN); Neelakantan Nurani Krishnan, San Jose, CA (US)

(21) Appl. No.: 17/951,775

(22) Filed: Sep. 23, 2022

(51) Int. Cl. H04W 72/08; H04L 5/00; H04W 72/04

(52) U.S. Cl. CPC H04W 72/085; H04L 5/0094; H04W 72/0453

(57) ABSTRACT

Methods, systems, and devices for wireless communications are described. A wireless device, such as an access point (AP), may perform a channel selection procedure that accounts for one or more sub-channels of a particular channel being punctured. For example, an AP may generate multiple channel efficiency metrics for multiple channels. The multiple channel efficiency metrics may be based on measuring the multiple channels and one or more subchannel puncturing patterns for the one or more channels of the multiple channels. The AP may transmit a message on a channel of the multiple channels based on a channel efficiency metric, of the multiple channel efficiency metrics, for the channel. The AP may transmit a control message including a puncture bitmap that indicates a subchannel puncturing pattern for one or more subchannels of the channel. The message may be transmitted on the channel in accordance with the puncture bitmap.

### BACKGROUND

The following relates to wireless communications, including techniques for channel selection.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a WLAN, such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via DL and UL. The DL (or forward link) may refer to the communication link from the AP to the station, and the UL (or reverse link) may refer to the communication link from the station to the AP.

A wireless network, such as a WLAN, may support one or more operations for channel selection, which may be performed by an AP. For example, an AP may perform an automatic channel selection (ACS) operation (e.g., procedure) to determine a channel for communications. Additionally, or alternatively, a wireless network may support channel puncturing. For example, wireless devices included in the wireless network may be configured to communicate using one or more punctured channels, which may include one or more non-contiguous frequency ranges (e.g., a punctured channel may include one or more subchannels that are not for communications). Conventional techniques for communicating using punctured channels are deficient.

### SUMMARY

The described techniques relate to improved methods, systems, devices, or apparatuses that support techniques for channel selection. Generally, the described techniques provide for an access point (AP) to perform a channel selection procedure that accounts for one or more sub-channels of a particular channel being punctured. For example, an AP may generate (e.g., determine) multiple channel efficiency metrics for multiple channels. The multiple channel efficiency metrics may be based on measuring the multiple channels. Additionally, or alternatively, the multiple channel efficiency metrics may be based on one or more subchannel puncturing patterns for the one or more channels of the multiple channels. The multiple channel efficiency metrics may include a channel efficiency metric and a bandwidth efficiency metric. The AP may transmit a message on a channel of the multiple channels based on a channel efficiency metric, of the multiple channel efficiency metrics, for the channel. In some cases, generating (e.g., determining) the multiple channel efficiency metrics may be based on a puncturing pattern, which may be indicated by a bitmap (e.g., a puncturing bitmap).

A method for wireless communication at an AP is described. The method may include generating a set of multiple channel efficiency metrics for a set of multiple channels, where the set of multiple channel efficiency metrics are based on measuring the set of multiple channels and one or more subchannel puncturing patterns for one or more channels of the set of multiple channels and transmitting a message on a channel of the set of multiple channels based on a channel efficiency metric, of the set of multiple channel efficiency metrics, for the channel.

An apparatus for wireless communication at an AP is described. The apparatus may include a processor, memory coupled with the processor, and instructions stored in the memory. The instructions may be executable by the processor to cause the apparatus to generate a set of multiple channel efficiency metrics for a set of multiple channels, where the set of multiple channel efficiency metrics are based on measuring the set of multiple channels and one or more subchannel puncturing patterns for one or more channels of the set of multiple channels and transmit a message on a channel of the set of multiple channels based on a channel efficiency metric, of the set of multiple channel efficiency metrics, for the channel.

Another apparatus for wireless communication at an AP is described. The apparatus may include means for generating a set of multiple channel efficiency metrics for a set of multiple channels, where the set of multiple channel efficiency metrics are based on measuring the set of multiple channels and one or more subchannel puncturing patterns for one or more channels of the set of multiple channels and means for transmitting a message on a channel of the set of multiple channels based on a channel efficiency metric, of the set of multiple channel efficiency metrics, for the channel.

A non-transitory computer-readable medium storing code for wireless communication at an AP is described. The code may include instructions executable by a processor to generate a set of multiple channel efficiency metrics for a set of multiple channels, where the set of multiple channel efficiency metrics are based on measuring the set of multiple channels and one or more subchannel puncturing patterns for one or more channels of the set of multiple channels and transmit a message on a channel of the set of multiple channels based on a channel efficiency metric, of the set of multiple channel efficiency metrics, for the channel.

Some examples of the method, apparatuses, and non-transitory computer-readable medium described herein may further include operations, features, means, or instructions for transmitting a control message including a puncture bitmap that indicates a subchannel puncturing pattern for one or more subchannels of the channel, where the message may be transmitted on the channel in accordance with the puncture bitmap.

Some examples of the method, apparatuses, and non-transitory computer-readable medium described herein may further include operations, features, means, or instructions for adjusting the channel efficiency metric for the channel of the set of multiple channels based on a quantity of subchannels of the channel that may be punctured according to a subchannel puncturing pattern.

In some examples of the method, apparatuses, and non-transitory computer-readable medium described herein, the channel efficiency metric may be adjusted by reducing the channel efficiency metric based on the quantity of punctured subchannels of the channel.

Some examples of the method, apparatuses, and non-transitory computer-readable medium described herein may further include operations, features, means, or instructions for generating a set of multiple bandwidth efficiency metrics for the set of multiple channels, and selecting the channel of the plurality of channels based at least in part on the plurality of bandwidth efficiency metrics.

In some examples of the method, apparatuses, and non-transitory computer-readable medium described herein, generating the set of multiple bandwidth efficiency metrics may include operations, features, means, or instructions for generating a bandwidth efficiency metric of the plurality of bandwidth efficiency metrics for the channel based at least in part on a plurality of probabilities that respective subchannels of the channel are occupied and based at least in part on whether one or more respective subchannels of the channel are punctured.

In some examples of the method, apparatuses, and non-transitory computer-readable medium described herein, the generated bandwidth efficiency metric may be a function of a set of multiple probabilities of a set of multiple subchannels of the channel being available.

In some examples of the method, apparatuses, and non-transitory computer-readable medium described herein, generating the set of multiple channel efficiency metrics may include operations, features, means, or instructions for generating the channel efficiency metric for the channel based on a throughput associated with the channel and a quantity of basic service sets within a range of the AP.

Some examples of the method, apparatuses, and non-transitory computer-readable medium described herein may further include operations, features, means, or instructions for selecting the channel from the set of multiple channels based on a comparison of the channel efficiency metric for the channel relative to channel efficiency metrics for other channels of the set of multiple channels.

Some examples of the method, apparatuses, and non-transitory computer-readable medium described herein may further include operations, features, means, or instructions for selecting the channel from the set of multiple channels based on the channel efficiency metric for the channel satisfying a threshold.

Some examples of the method, apparatuses, and non-transitory computer-readable medium described herein may further include operations, features, means, or instructions for measuring a set of multiple channel metrics including a noise floor metric, a received signal strength indicator, a quantity of overlapping basic service sets, a spatial reuse parameter, a channel utilization, a throughput, and a transmit power, where the set of multiple channel efficiency metrics may be based on the set of multiple channel metrics.

In some examples of the method, apparatuses, and non-transitory computer-readable medium described herein, the channel efficiency metric may be a function of a bandwidth of the channel, a throughput for the channel, a quantity of overlapping basic service sets within a proximity of the AP, and one or more weighting factors corresponding to respective types of clients.

In some examples of the method, apparatuses, and non-transitory computer-readable medium described herein, the channel efficiency metric may be based on a frequency location of a punctured subchannel within a bandwidth of the channel.

A method for wireless communication at an AP is described. The method may include generating a set of multiple channel efficiency metrics for a set of multiple channels, where the set of multiple channel efficiency metrics are based on measuring the set of multiple channels and one or more subchannel puncturing patterns for one or more channels of the set of multiple channels and transmitting a message on a channel of the set of multiple channels based on a channel efficiency metric, of the set of multiple channel efficiency metrics, for the channel.

An apparatus for wireless communication at an AP is described. The apparatus may include a processor, memory coupled with the processor, and instructions stored in the memory. The instructions may be executable by the processor to cause the apparatus to generate a set of multiple channel efficiency metrics for a set of multiple channels, where the set of multiple channel efficiency metrics are based on measuring the set of multiple channels and one or more subchannel puncturing patterns for one or more channels of the set of multiple channels and transmit a message on a channel of the set of multiple channels based on a channel efficiency metric, of the set of multiple channel efficiency metrics, for the channel.

Another apparatus for wireless communication at an AP is described. The apparatus may include means for generating a set of multiple channel efficiency metrics for a set of multiple channels, where the set of multiple channel efficiency metrics are based on measuring the set of multiple channels and one or more subchannel puncturing patterns for one or more channels of the set of multiple channels and means for transmitting a message on a channel of the set of multiple channels based on a channel efficiency metric, of the set of multiple channel efficiency metrics, for the channel.

A non-transitory computer-readable medium storing code for wireless communication at an AP is described. The code may include instructions executable by a processor to generate a set of multiple channel efficiency metrics for a set of multiple channels, where the set of multiple channel efficiency metrics are based on measuring the set of multiple channels and one or more subchannel puncturing patterns for one or more channels of the set of multiple channels and transmit a message on a channel of the set of multiple channels based on a channel efficiency metric, of the set of multiple channel efficiency metrics, for the channel.

Some examples of the apparatus may include means for transmitting a control message including a puncture bitmap that indicates a subchannel puncturing pattern for one or more subchannels of the channel, where the message may be transmitted on the channel in accordance with the puncture bitmap.

Some examples of the apparatus may include means for adjusting the channel efficiency metric for the channel of the set of multiple channels based on a quantity of subchannels of the channel that may be punctured according to a subchannel puncturing pattern.

A method for wireless communication at an AP is described. The method may include generating a set of multiple channel efficiency metrics for a set of multiple channels, where the set of multiple channel efficiency metrics are based on measuring the set of multiple channels and one or more subchannel puncturing patterns for one or more channels of the set of multiple channels and transmitting a message on a channel of the set of multiple channels based on a channel efficiency metric, of the set of multiple channel efficiency metrics, for the channel.

An apparatus for wireless communication at an AP is described. The apparatus may include a processor, memory coupled with the processor, and instructions stored in the memory. The instructions may be executable by the processor to cause the apparatus to generate a set of multiple channel efficiency metrics for a set of multiple channels, where the set of multiple channel efficiency metrics are based on measuring the set of multiple channels and one or more subchannel puncturing patterns for one or more channels of the set of multiple channels and transmit a message on a channel of the set of multiple channels based on a channel efficiency metric, of the set of multiple channel efficiency metrics, for the channel.

Another apparatus for wireless communication at an AP is described. The apparatus may include means for generating a set of multiple channel efficiency metrics for a set of multiple channels, where the set of multiple channel efficiency metrics are based on measuring the set of multiple channels and one or more subchannel puncturing patterns for one or more channels of the set of multiple channels and means for transmitting a message on a channel of the set of multiple channels based on a channel efficiency metric, of the set of multiple channel efficiency metrics, for the channel.

A non-transitory computer-readable medium storing code for wireless communication at an AP is described. The code may include instructions executable by a processor to generate a set of multiple channel efficiency metrics for a set of multiple channels, where the set of multiple channel efficiency metrics are based on measuring the set of multiple channels and one or more subchannel puncturing patterns for one or more channels of the set of multiple channels and transmit a message on a channel of the set of multiple channels based on a channel efficiency metric, of the set of multiple channel efficiency metrics, for the channel.

### BRIEF DESCRIPTION OF THE DRAWINGS

FIG. 1 illustrates an example of a wireless local area network that supports techniques for channel selection in accordance with aspects of the present disclosure.

FIG. 2 illustrates an example of a flowchart that supports techniques for channel selection in accordance with one or more aspects of the present disclosure.

FIG. 3 illustrates an example of a process flow that supports techniques for channel selection in accordance with one or more aspects of the present disclosure.

FIGS. 4 and 5 show block diagrams of devices that support techniques for channel selection in accordance with one or more aspects of the present disclosure.

FIG. 6 shows a block diagram of a communications manager that supports techniques for channel selection in accordance with one or more aspects of the present disclosure.

FIG. 7 shows a diagram of a system including a device that supports techniques for channel selection in accordance with one or more aspects of the present disclosure.

FIGS. 8 and 9 show flowcharts illustrating methods that support techniques for channel selection in accordance with one or more aspects of the present disclosure.

### DETAILED DESCRIPTION

Some wireless communications systems may support channel selection procedures (e.g., automatic channel selection (ACS)) for communications between wireless devices. For example, a wireless device, such as an access point (AP), may perform one or more operations to determine a channel for communications (e.g., to determine one or more time-frequency resources for communications) with other wireless devices (e.g., one or more stations (STAs)). In some cases, performing the one or more operations to determine (e.g., select) the channel may enable a wireless device to effectively communicate (e.g., to minimize interference, to increase throughput) while using one or more channels of a set of channels. However, a first channel selection procedure (e.g., implemented by conventional APs) may not account for one or more punctured channels (e.g., channels including two or more non-contiguous frequency ranges), which may be present in some wireless communications systems (e.g., wireless communications systems that operate according to IEEE 802.11be protocols). In such cases, an AP (e.g., performing the first channel selection procedure) may not identify that a channel is punctured and may accordingly miscalculate one or more parameters (e.g., metrics) associated with the channel. For example, an AP may overestimate a throughput for a punctured channel. In some cases, the first channel selection procedure may not be able to determine channel metrics (e.g., channel quality metrics) for one or more punctured channels (e.g., techniques for determining parameters may not account for channel puncturing). Accordingly, performing the first channel selection procedure in a wireless communications system that supports channel puncturing may limit an ability of an AP to effectively select an optimal channel, which may reduce throughput. For example, a punctured channel may have a lower throughput, when compared to other channels (e.g., other channels that are not punctured), and in such cases, an AP may fail to identify and accurately measure (e.g., account for) the reduced throughput of the punctured channel.

In some implementations of the present disclosure, a wireless device (e.g., an AP) may perform a second channel selection procedure (e.g., different from the first channel selection procedure) that accounts for one or more sub-channels of a particular channel being punctured. For example, an AP may generate multiple channel efficiency metrics for multiple channels. The multiple channel efficiency metrics may be based on measuring the multiple channels. Additionally, or alternatively, the multiple channel efficiency metrics may be based on one or more subchannel puncturing patterns for the one or more channels of the multiple channels. A subchannel puncturing pattern may indicate one or more subchannels of a channel bandwidth that are unavailable for communication. For example, a 160 MHz channel may include a set of eight 20 MHz subchannels that are respectively adjacent in frequency, and the subchannel puncturing pattern may indicate that one or more of the eight 20 MHz subchannels are punctured. The AP may transmit a message on a channel of the multiple channels based on a channel efficiency metric, of the multiple channel efficiency metrics, for the channel. Accordingly, basing the multiple channel efficiency metrics on the one or more subchannel puncturing patterns may improve quality and effectiveness of communications between the AP and STAs. For example, the channel may be associated with a higher throughput when compared to other channels, which may result in improved communications when compared to communications using other channels. In such cases, the AP may select the channel (e.g., with higher throughput) based on determining that one or more other channels may have reduced throughput (e.g., due to puncturing).

Such implementations of the subject matter described in this disclosure can be implemented to realize one or more of the following potential advantages. For example, an AP may generate multiple channel efficiency metrics for multiple channels where the multiple channel efficiency metrics are based on measuring the multiple channels and one or more subchannel puncturing patterns. Accordingly, generating the multiple channel efficiency metrics as described herein may improve communication reliability (e.g., for the AP and STAs) by accounting for the one or more subchannel puncturing patterns. Additionally, or alternatively, an AP may transmit a message on a channel of the multiple channels, which may improve channel utilization (e.g., the AP and STAs may utilize more efficient channels, which may be punctured). In some cases, an AP may transmit a control message (e.g., to an STA) that includes a puncture bitmap indicating a subchannel puncturing pattern. The AP may transmit one or more messages on a channel according to the puncture bitmap, which may improve communication reliability. In such cases, an STA may determine to monitor the channel according to the puncture bitmap, which may increase a likelihood than the message is received by the STA.

Aspects of the disclosure are initially described in the context of a wireless communications system. Aspects of the disclosure are further illustrated by and described with reference to a process flow, apparatus diagrams, system diagrams, and flowcharts that relate to techniques for channel selection

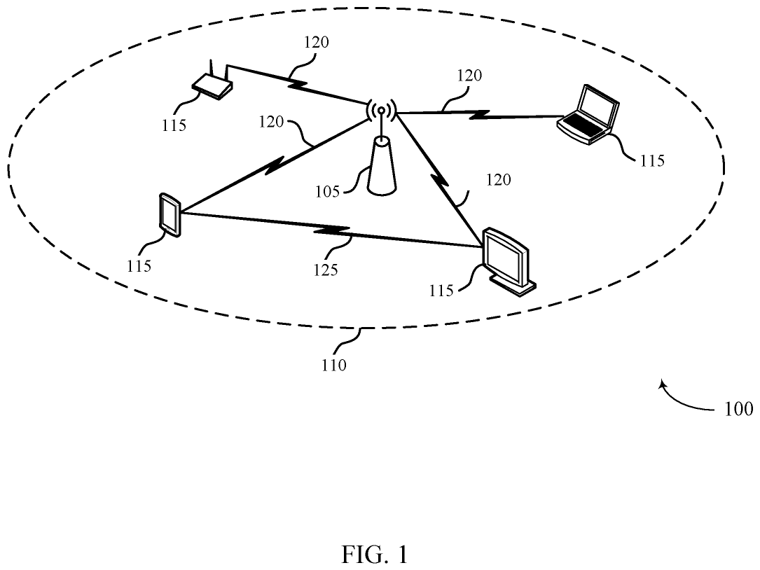

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station (not shown) associated with the WLAN 100 may be connected to a wired or wireless distribution system that may allow multiple APs 105 to be connected in an ESS.

The WLAN 100 may support channel selection procedures for communications between APs 105 and STAs 115. For example, an AP 105 may perform one or more operations to determine a channel for communications (e.g., to determine one or more time-frequency resources for communications) with one or more STAs 115. In some cases, performing the one or more operations to determine (e.g., select) the channel may enable an AP 105 to effectively communicate (e.g., to minimize interference, to increase throughput) while using one or more channels of a set of channels. However, a first channel selection procedure (e.g., implemented by conventional APs 105) may not account for one or more punctured channels (e.g., channels including two or more non-contiguous frequency ranges), which may be present in the WLAN 100. Additionally, or alternatively, the first channel selection procedure may not be able to determine channel metrics (e.g., channel quality metrics) for one or more punctured channels (e.g., techniques for determining parameters may not account for channel puncturing). Accordingly, performing the first channel selection procedure in the WLAN 100 (e.g., that supports channel puncturing) may limit an ability of an AP 105 to effectively select a channel, which may reduce throughput.

In some implementations of the present disclosure, an AP 105 may perform a second channel selection procedure (e.g., different from the first channel selection procedure) that accounts for one or more sub-channels of a particular channel being punctured. For example, the second channel selection procedure may include selecting one or more channels from a second set of channels including one or more punctured channels. Accordingly, the second channel selection procedure may include determining one or more channel metrics (e.g., channel quality metrics) for the second set of channels (e.g., punctured and non-punctured channels). In some cases, the second channel selection procedure may include determining metrics (e.g., channel efficiency metrics) for punctured channels. In some cases, determining the metrics for the punctured channels may be based on a puncturing pattern (e.g., a parameter may be calculated using a weighting based on a puncturing bitmap). In some cases, the second channel selection procedure may provide one or more potential advantages when compared to the first channel selection procedure, such as reducing a complexity of selecting one or more channels (e.g., as a result of reduced computational complexity). Additionally, or alternatively, the second channel selection procedure may reduce processing overhead, which may enable some lower cost devices (e.g., with reduced processing capabilities when compared to conventional devices) to effectively perform the second channel selection procedure.

In some cases, an AP 105 may consider multiple conditions for puncturing (e.g., static puncturing). For example, the AP 105 may consider continuous wave communications, automatic frequency coordination (AFC), radar non-occupancy list (NOL), weather channels (e.g., weather radar channels). Additionally, or alternatively, an AP 105 may select one or more punctured channels based on one or more guidelines. For example, an AP 105 may select a punctured channel with a defined or minimum punctured bandwidth. Additionally, or alternatively, the AP 105 may select a punctured channel based on a position of (e.g., location of) puncturing that reduces or minimizes impact to bandwidth for some clients (e.g., legacy clients). In some cases, the AP 105 may select a punctured channel based on throughput or goodput of the punctured channel, which may be indicated by clear channel assessment (CCA) statistics (e.g., parameters). For example, an AP 105 may select a punctured channel with relatively high throughput or goodput when compared to one or more punctured channels that are not selected.

Channel puncturing may have different effects on different types of clients (e.g., legacy clients and IEEE 802.11be clients). As described herein, an AP 105 may calculate a channel efficiency for different client types \and unify them (e.g., perform an averaging or other mathematical operation) using weightings (e.g., each channel efficiency value is weighted based on client type). In some cases, each weighting may be configurable. The AP 105 may assign a weighting to legacy clients, IEEE 802.11be orthogonal frequency division multiple access (OFDMA) clients, and IEEE 802.11be non-OFDMA clients.

As described herein, an AP 105 may calculate channel efficiency metrics for one or more channels of a list of channels. The list of channels may include one or more punctured channels, which may be punctured according to puncture bitmaps. As an illustrative example, Equation 1 may be used to calculate a channel efficiency metric (e.g., CH Eff) for a channel (e.g., a punctured channel) with a grade of 100, a channel width of 160 MHz, a puncture bitmap of P1111101, and weightings of 50%, 25%, and 25% (e.g., for legacy clients, IEEE 802.11be non-OFDMA clients, and IEEE 802.11be OFDMA clients).

Ch Eff=(50/100)*100*(80/160)+(25/100)*100*(140/160)+(25/100)*100*(140/160)=25+43.75=68.75 (1)

In Equation 1, the quantity “(80/160)” may correspond to 80 MHz of a 160 MHz channel being punctured. Accordingly, 80 MHz of a 160 MHz bandwidth may be available for communications. Similarly, the quantity, the quantity “(140/160)” may correspond to 20 MHz of a 160 MHz channel being punctured. Accordingly, 140 MHz of a 160 MHz bandwidth may be available for communications. Additionally, or alternatively, Equation 2 may be used to calculate a channel efficiency metric (e.g., CH Eff) for a channel (e.g., a punctured channel) with a grade of 100, a channel width of 160 MHz, a puncture bitmap of P1011111, and weightings of 50%, 25%, and 25% (e.g., for legacy clients, IEEE 802.11be non-OFDMA clients, and IEEE 802.11be OFDMA clients).

Ch Eff=(50/100)*100*(40/160)+(25/100)*100*(140/160)+(25/100)*100*(140/160)=12.5+43.75=56.25 (2)

Additionally, or alternatively, Equation 3 may be used to calculate a channel efficiency metric (e.g., CH Eff) for a channel (e.g., a punctured channel) with a grade of 100, a channel width of 160 MHz, a puncture bitmap of P0111111, and weightings of 50%, 25%, and 25% (e.g., for legacy clients, IEEE 802.11be non-OFDMA clients, and IEEE 802.11be OFDMA clients).

Ch Eff=(50/100)*100*(20/160)+(25/100)*100*(140/160)+(25/100)*100*(140/160)=6.25+43.75=50 (3)

Additionally, or alternatively, Equation 4 may be used to calculate a channel efficiency metric (e.g., CH Eff) for a channel (e.g., a punctured channel) with a grade of 100, a channel width of 160 MHz, a puncture bitmap of P0111011, and weightings of 50%, 25%, and 25% (e.g., for legacy clients, IEEE 802.11be non-OFDMA clients, and IEEE 802.11be OFDMA clients).

Ch Eff=(50/100)*100*(20/160)+(25/100)*100*(60/160)+(25/100)*100*(120/160)=6.25+43.75=34.375 (4)

As described herein, an AP 105 may calculate bandwidth efficiency metrics for one or more channels of a list of channels. In some cases, an AP 105 may calculate one or more bandwidth efficiency metrics as an alternative to calculating one or more channel load metrics. In some cases, calculating bandwidth efficiency metrics may reflect dynamic puncturing. A bandwidth efficiency metric may be based on a channel load per 20 MHz channel. Additionally, or alternatively, an AP 105 may calculate bandwidth efficiency to represent channel load with different dynamic bandwidth and dynamic puncturing options. In similarity to channel efficiency metrics, bandwidth efficiency metrics may be calculated using weightings based on client type. For example, an AP 105 may assign a weighting to legacy clients, IEEE 802.11be OFDMA clients, and IEEE 802.11be non-OFDMA clients. The AP 105 may unify bandwidth efficiencies for each client type using the weightings.

To calculate bandwidth efficiency metrics, an AP 105 may determine (e.g., find) probabilities of different bandwidths being free. To determine a probability of a specific bandwidth being free, an AP 105 may use a minimum of all probabilities for each subchannel within a channel (e.g., each 20 MHz bandwidth). In some cases, a minimum probability of a subchannel may correspond to a best case scenario where free times on all channels align for stronger comparison between alternatives. In some cases, an AP 105 may calculate one or more channel efficiency metrics based on probabilities of different bandwidths (e.g., different subchannels) being free. In some cases, calculating bandwidth efficiency metrics may provide one or more potential advantages when compared to other calculations (e.g., legacy calculations) for channel selection, such as reducing a complexity of selecting one or more channels (e.g., as a result of reduced computational complexity). Additionally, or alternatively, the calculating bandwidth efficiency metrics may reduce processing overhead, which may enable some lower cost devices (e.g., with reduced processing capabilities when compared to conventional devices) to effectively perform channel selection procedures.

As an illustrative example for legacy client view dynamic bandwidth, a 160 MHz channel may have channel loads in percentages per 20 MHz (e.g., starting with a primary 20 MHz subchannel) of 10%, 10%, 80%, 10%, 10%, 10%, 10%, and 10%. For example, a 160 MHz channel may be split into 8 different 20 MHz subchannels, and each 20 MHz subchannel may be have a respective channel load, which may be expressed as a percentage. In accordance with one illustrative example described herein, 10% of a first 20 MHz subchannel may be occupied, 10% of a second 20 MHz subchannel may be occupied, 80% of a third 20 MHz subchannel may be occupied, and so forth. Additionally, or alternatively, example bandwidths may be 160 MHz, 80 MHz, 40 MHz, and 20 MHz. That is, bandwidth efficiency may be calculated (e.g., determined) for a set of channel combinations, which may include a 160 MHz bandwidth (e.g., the entire 160 MHz channel), an 80 MHz bandwidth, a 40 MHz bandwidth, and a 20 MHz bandwidth. Although specific examples of bandwidths are described for illustrative clarity, any combination of bandwidths may be used. In some cases, an AP 105 may determine a respective bandwidth efficiency for each potential bandwidth and then sum the respective bandwidth efficiencies to determine a bandwidth efficiency (e.g., an overall bandwidth efficiency) for a 160 MHz channel.

As an illustrative example, probabilities of free channels (e.g., free subchannels of the 160 MHz bandwidth) may be 0.9, 0.9, 0.2, 0.9, 0.9, 0.9, 0.9, 0.9. For a 160 MHz bandwidth, an AP 105 may determine a minimum probability from a first set of probabilities (0.9, 0.9, 0.2, 0.9, 0.9, 0.9, 0.9, 0.9) (e.g., 0.2). For an 80 MHz bandwidth, the AP 105 may determine a minimum probability from a second set of probabilities (0.7, 0.7, 0.0, 0.7) (e.g., 0.0). The second set of probabilities may exclude transmissions corresponding to the first set of probabilities. For a 40 MHz bandwidth, the AP 105 may determine a minimum probability from a third set of probabilities (0.7, 0.7) (e.g., 0.7). The third set of probabilities may exclude transmissions corresponding to the first set of probabilities and the second set of probabilities. For a 20 MHz bandwidth, the AP 105 may determine a minimum probability from a fourth set of probabilities (0.0) (e.g., 0.0). The fourth set of probabilities may exclude transmissions corresponding to the first, second, and third sets of probabilities. The AP 105 may then calculate a bandwidth efficiency using Equation 5.

BW Eff=((160/160)*(20/100))+((80/160)*(0/100))+((40/160)*(70/100))+((20/160)*(0/100))=37.5 (5)

As an illustrative example for IEEE 802.11be non-OFDMA view dynamic puncturing, a 160 MHz channel may have channel loads in percentages per 20 MHz (e.g., starting with a primary 20 MHz subchannel) of 10%, 10%, 80%, 10%, 10%, 10%, 10%, and 10%. Additionally, or alternatively, example bandwidths may be 160 MHz, 160 MHz with 20 MHz punctured, 160 MHz with 40 MHz punctured, 80 MHz, 80 MHz with 20 MHz punctured, 40 MHz, and 20 MHz. For a 160 MHz bandwidth, an AP 105 may determine a minimum probability from a first set of probabilities (0.9, 0.9, 0.2, 0.9, 0.9, 0.9, 0.9, 0.9) (e.g., 0.2). For a 140 MHz bandwidth, the AP 105 may determine a minimum probability from a second set of probabilities (0.7, 0.7, P, 0.7, 0.7, 0.7, 0.7, 0.7) (e.g., 0.7). For 80 MHz, 40 MHz, and 20 MHz bandwidths, the AP 105 may determine a minimum probability from a third set of probabilities (0.0, 0.0, 0.0, 0.0) (e.g., 0.0). The AP 105 may then calculate a bandwidth efficiency using Equation 6.

BW Eff=((160/160)*(20/100))+((140/160)*(70/100))+((80/160)*(0/100))+((40/160)*(0/100))+((20/160)*(0/100))=81.25 (6)

As an illustrative example for IEEE 802.11be OFDMA view dynamic puncturing, a 160 MHz channel may have channel loads in percentages per 20 MHz (e.g., starting with a primary 20 MHz subchannel) of 10%, 10%, 80%, 10%, 10%, 10%, 10%, and 10%. Additionally, or alternatively, example bandwidths (e.g., for a first 80 MHz segment) may be 80 MHz, 80 MHz with 20 MHz punctured, 80 MHz with 40 MHz punctured, 40 MHz, and 20 MHz. For an 80 MHz bandwidth, an AP 105 may determine a minimum probability from a first set of probabilities (0.9, 0.9, 0.2, 0.9) (e.g., 0.2). For a 60 MHz bandwidth, the AP 105 may determine a minimum probability from a second set of probabilities (0.7, 0.7, P, 0.7) (e.g., 0.7). For 40 MHz and 20 MHz bandwidths, the AP 105 may determine a minimum probability from a third set of probabilities (0.0, 0.0, 0.0, 0.0) (e.g., 0.0). The AP 105 may then calculate a bandwidth efficiency (e.g., for the first 80 MHz segment) using Equation 7.

BW Eff=((80/80)*(20/100))+((60/80)*(70/100))+((40/160)*(0/100))+((20/160)*(0/100))=72.5 (7)

Additionally, or alternatively, example bandwidths (e.g., for a second 80 MHz segment) may be 80 MHz, 80 MHz with 20 MHz punctured, 40 MHz, and 20 MHz. For an 80 MHz bandwidth, an AP 105 may determine a minimum probability from a first set of probabilities (0.9, 0.9, 0.9, 0.9) (e.g., 0.9). For 60 MHz, 40 MHz, and 20 MHz bandwidths, the AP 105 may determine a minimum probability from a second set of probabilities (0.0, 0.0, 0.0, 0.0) (e.g., 0.0). The AP 105 may then calculate a bandwidth efficiency (e.g., for the second 80 MHz segment) using Equation 8.

BW Eff=((80/80)*(90/100))+((60/80)*(0/100))+((0/160)*(0/100))+((0/160)*(0/100))=90.0 (8)

The AP 105 may then average the bandwidth efficiencies for the first 80 MHz and the second 80 MHz segment to determine a bandwidth efficiency of 81.25. Additionally, or alternatively, the AP 105 may calculate an overall bandwidth efficiency using Equation 9.

BW Eff=(0.5*37.5)+(0.25*81.25)+(0.25*81.25)=59.375 (9)

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11be, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

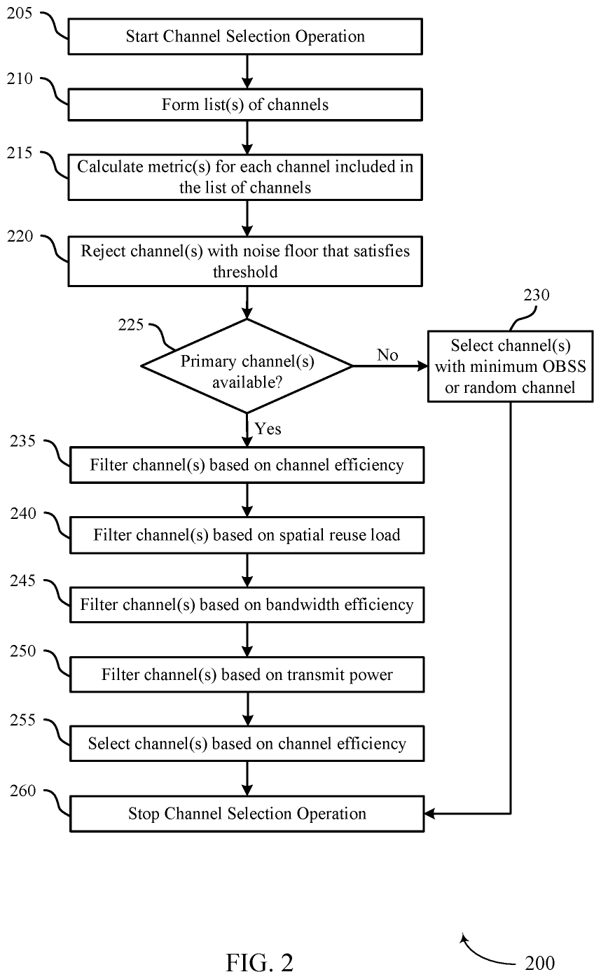

FIG. 2 illustrates an example of a flowchart 200 that supports techniques for channel selection in accordance with one or more aspects of the present disclosure. One or more aspects of the flowchart 200 may be implemented by one or more aspects of the WLAN 100. For example, an AP 105, as described with reference to FIG. 1, may implement (e.g., perform one or more operations of) the flowchart 200 (e.g., as part of a channel selection procedure). In the following description of the flowchart 200, the operations may occur in a different order than the order shown, or the operations may be performed at different times. Some operations may also be left out of flowchart 200, or other operations may be added to the flowchart 200.

At 205, an AP 105 may start a channel selection operation (e.g., an automatic channel selection (ACS) operation). The channel selection operation may enable the AP 105 to select a channel (e.g., an optimal channel, a channel that satisfies one or more thresholds) from one or more lists of channels for communications with one or more STAs 115 (e.g., within the coverage area 110). The channel selection operation may be performed based on initializing or powering on the AP 105. In some cases, the channel selection operation may be performed periodically. The channel selection operation may be an example of an ACS operation, which may be performed in accordance with one or more aspects of a communications standard (e.g., protocol), such as IEEE 802.11be. The communication standard may include one or more protocols for communications using channel puncturing and overlapping 320 MHz channels. Accordingly, an AP 105 that performs the channel selection operation may communicate using channel puncturing and overlapping 320 MHz channels. In some cases, an AP 105 may consider 320 MHz overlapping channels as separate channel combinations and determine to use a different channel selection operation (e.g., an existing algorithm, a legacy ACS operation). As used herein, “satisfying a threshold” may, depending on the context, refer to a value being greater than the threshold, greater than or equal to the threshold, less than the threshold, less than or equal to the threshold, equal to the threshold, not equal to the threshold, or the like.

At 210, an AP 105 may form (e.g., construct, determine, generate, compile, select) a first list of channels and a second list of channels. The first list of channels and the second list of channels may each include one or more punctured channels. The first list of channels (e.g., where each channel is 20 MHz bandwidth) may include a quantity of channels (e.g., all possible channels) for a user configured bandwidth. Additionally, or alternatively, the first list of channels may include punctured channels based on AFC or other regulations (e.g., other protocols for determining if a subset of channels may be accessed by the AP 105). The second list of channels may include the first list of channels and one or more channels that are adjacent to the first list of channels. The second list of channels may be for scanning. As described herein, the phrase “list of channels” may be used interchangeably to refer to the first list of channels and the second list of channels. For example, the AP 105 may perform the channel selection operation using the first list of channels, the second list of channels, or both. In some cases, for the list of channels that are selected for a scan (e.g., a channel survey, the channel selection operation), the AP 105 may stay on each channel for a configured dwell time and collect stats (e.g., metrics) for each channel.

In some cases, an AP 105 may be configured to transmit and receive communications within a bandwidth, which may be configured by a user. The bandwidth may include a range of frequencies for wireless communications. In some cases, the bandwidth may include multiple channels. For example, the bandwidth may be a 160 MHz bandwidth, which may be divided into 20 MHz channels (e.g., subchannels). In some cases, the bandwidth may include one or more punctured channels. For example, one or more channels within the bandwidth may include multiple non-contiguous frequency ranges. In such cases, a punctured channel may include a first frequency range of 20 MHz for communications, a second frequency range of 20 MHz that is punctured (e.g., not for communications), and a third frequency range of 20 MHz for communications, and additional frequency ranges that may be punctured or for communications. The first frequency range and the third frequency range may be non-contiguous. In some cases, the AP 105 may from the list of channels based on a mode (e.g., an operation mode for the AP 105).

At 215, an AP 105 may determine (e.g., calculate) one or more metrics (e.g., internal and external metrics) for each channel included in the list of channels. In some cases, to measure the one or more metrics for each channel, the AP 105 may access, establish a connection, or otherwise communicate with an STA 115 using each channel of the list of channels. For example, an AP 105 may transmit one or more reference signals to an STA 115 on each channel of the list of channels. Additionally, or alternatively, the STA 115 may transmit one or more reference signals to the AP 105. The AP 105 may access or otherwise perform communications (e.g., transmit reference signaling, receive reference signaling) on each channel of the list of channels for a duration (e.g., a dwell time). In some cases, the dwell time may be configurable. In some other cases, the dwell time may be a fixed value, such as 300 milliseconds (ms). In some cases, the AP 105 may determine the one or more metrics for each channel included in the list of channels based on reference signaling (e.g., measurements of reference signals received from one or more other APs, one or more STAs, or both, indications of measurements for transmitted reference signals).

The one or more channel metrics may include a noise floor, a received signal strength indicator (RSSI), a quantity of overlapping BSSs (OBSSs), a spatial reuse parameter (SRP), a channel utilization, a transmit power, a channel grade, a channel efficiency, and a bandwidth efficiency. As described herein, the phrases “channel utilization,” “channel load,” “channel availability,” and “probability of a channel being free,” may be used interchangeably. In some cases, one or more channel metrics may be determined (e.g., calculated) based on one or more other channel metrics (e.g., parameters). For example, an AP 105 may determine (e.g., calculate) channel grade based on a spur parameter (e.g., for spurious tones), a noise floor, a transmit power, or any other metric (e.g., parameter) associated with a channel. The AP 105 may determine the channel grade from a bus device function (BDF) during device initialization. The channel grade may indicate a value (e.g., from 0 to 100) corresponding to a throughput of a channel. For example, a channel grade of 1 may indicate a relatively low throughput when compared to a channel grade of 100. In some cases, a channel grade of 0 may indicate that a channel is unusable (e.g., blocked). In some cases (e.g., in legacy networks), multiple channel metrics (e.g., noise floor, RSSI, quantity of OBSSs, SRP, channel utilization, transmit power) may be measured for each channel of the list of channels, which may include one or more punctured channels. In some cases, multiple channel metrics may be measured for each 20 MHz bandwidth included in a scan of a larger bandwidth, such as 160 MHz or 320 MHz (e.g., a channel selection operation). An AP 105 may determine one or more channel metrics based on one or more beacons. For example, an AP 105 may perform a beacon processing operation to extract information associated with one or more punctured channels.

At 220, an AP 105 may filter (e.g., update) the list of channels by removing one or more channels with noise floors that satisfy a threshold value (e.g., a threshold noise floor). For example, the AP 105 may filter the list of channels by removing one or more channels from the list of channels if the one or more channels have noise floors that are greater than a threshold noise floor. The threshold noise floor may be determined based on a configuration. In some other cases, the threshold noise floor may be based on an average of respective noise floors for each channel of the list of channels. In some cases, the threshold noise floor may be a fixed value. In some other cases, the threshold noise floor may be configured dynamically (e.g., based on one or more parameters). As described herein, the phrase “list of channels” may be used interchangeably to describe the list of channels both prior to and subsequent to one or more filtering operations (e.g., to update the list of channels). For example, the phrase “list of channels” may refer to an initial list of channels formed by an AP 105 (e.g., at 210), an updated list of channels filtered by the AP (e.g., at 220, at 235, at 240, at 245, and at 250). Accordingly, an interpretation of the phrase “list of channels” may depend on a context that indicates a step of the flowchart 200 for which the phrase “list of channels” is being used to describe. For example, the list of channels described with reference to a first step (e.g., at 210) may be different from the list of channels described with reference to a second step (e.g., at 250).

At 225, an AP 105 may determine if a quantity of channels (e.g., primary channels) are available. For example, an AP 105 may determine if zero primary channels are available. In some cases, a primary channel may be an example of a channel for communications between an AP 105 and an STA 115 (e.g., a channel included in the first set of channels). In some cases, the AP 105 may determine if the quantity of channels (e.g., primary channels) are available based on (e.g., from) the list of channels, which may be filtered based on respective noise floors of each channel (e.g., at 220). The AP 105 may then (e.g., at 225) determine if zero primary channels are available from the list of channels.

At 230, if the list of channels does not include any available channels, the AP 105 may select one or more channels (e.g., from the list of channels) based on a quantity of OBSSs associated with the one or more channels. In some cases, the AP 105 may select a channel from the list of channels based on determining that the channel has a minimum quantity of OBSSs when compared to other channels included in the list of channels. In some other cases, the AP 105 may select one or more channels from the list of channels based on determining whether the one or more channels have respective quantities of OBBSs that are below a threshold quantity of OBBSs. In some other cases, the AP 105 may select one or more random channels from the list of channels.

At 235, if the list of channels does include available channels, the AP 105 may filter (e.g., update) the list of channels based on a channel efficiency metric for each channel. Some illustrative examples of channel efficiency calculations are provided by Equations 1-4, which are described in further detail with reference to FIG. 1. In some cases, the AP 105 may remove one or more channels from the list of channels with respective channel efficiency metrics that satisfy a threshold channel efficiency (e.g., a respective channel efficiency metric that is below the threshold channel efficiency with a channel efficiency variance). The channel efficiency variance may be a range of variation for channel efficiency values. The threshold channel efficiency may be determined based on a configuration. In some other cases, the threshold channel efficiency may be based on an average of respective channel efficiency metrics for each channel of the list of channels. In some cases, the threshold channel efficiency may be a fixed value. In some other cases, the threshold channel efficiency may be configured dynamically (e.g., based on one or more parameters).

At 240, the AP 105 may filter (e.g., update) the list of channels based on a spatial reuse load for each channel. In some cases, the AP 105 may remove one or more channels from the list of channels with respective spatial reuse loads that satisfy a threshold spatial reuse load (e.g., with spatial reuse loads that are greater than the threshold spatial reuse load with a spatial reuse load variance). The spatial reuse load variance may be a range of variation for spatial reuse load values. The threshold spatial reuse load may be determined based on a configuration. In some other cases, the threshold spatial reuse load may be based on an average of respective spatial reuse loads for each channel of the list of channels. In some cases, the threshold spatial reuse load may be a fixed value. In some other cases, the threshold spatial reuse load may be configured dynamically (e.g., based on one or more parameters).

At 245, the AP 105 may filter (e.g., update) the list of channels based on a bandwidth efficiency metric for each channel. Some illustrative examples of bandwidth efficiency calculations are provided by Equations 5-9, which are described in further detail with reference to FIG. 1. In some cases, the AP 105 may remove one or more channels from the list of channels with respective bandwidth efficiency metrics that satisfies a threshold bandwidth efficiency metric (e.g., a respective bandwidth efficiency that is greater than the threshold bandwidth efficiency with a bandwidth efficiency variance). The bandwidth efficiency variance may be a range of variation for bandwidth efficiency values. The threshold bandwidth efficiency may be determined based on a configuration. In some other cases, the threshold bandwidth efficiency may be based on an average of respective bandwidth efficiencies for each channel of the list of channels. In some cases, the threshold bandwidth efficiency may be a fixed value. In some other cases, the threshold bandwidth efficiency may be configured dynamically (e.g., based on one or more parameters).

At 250, the AP 105 may filter (e.g., update) the list of channels based on a transmit power for each channel. For example, the AP 105 may apply a regulatory filter. In some cases, the AP 105 may remove one or more channels from the list of channels with respective transmit powers that satisfy a threshold transmit power (e.g., respective transmit powers that are less than the threshold transmit power with a transmit power variance). The transmit power variance may be a range of variation for transmit power values. The threshold transmit power may be determined based on a configuration. In some other cases, the threshold transmit power may be based on an average of respective transmit powers for each channel of the list of channels. In some cases, the threshold transmit power may be a fixed value. In some other cases, the threshold transmit power may be configured dynamically (e.g., based on one or more parameters).

At 255, the AP 105 may select a channel from the list of channels based on a channel efficiency for each channel. In some cases, the AP 105 may select a channel from the list of channels based on determining that the channel (e.g., the selected channel) has a highest channel efficiency (e.g., a maximum channel efficiency) when compared to other channels included in the list of channels. The AP 105 may communicate with one or more STAs 115 on the channel (e.g., the selected channel). In some cases, selecting the channel from the list of channel may enable the AP 105 to increase quality and efficiency for communications. For example, selecting the channel from the list of channels may improve communication performance. At 260, the AP 105 may stop (e.g., terminate) the channel selection operation.

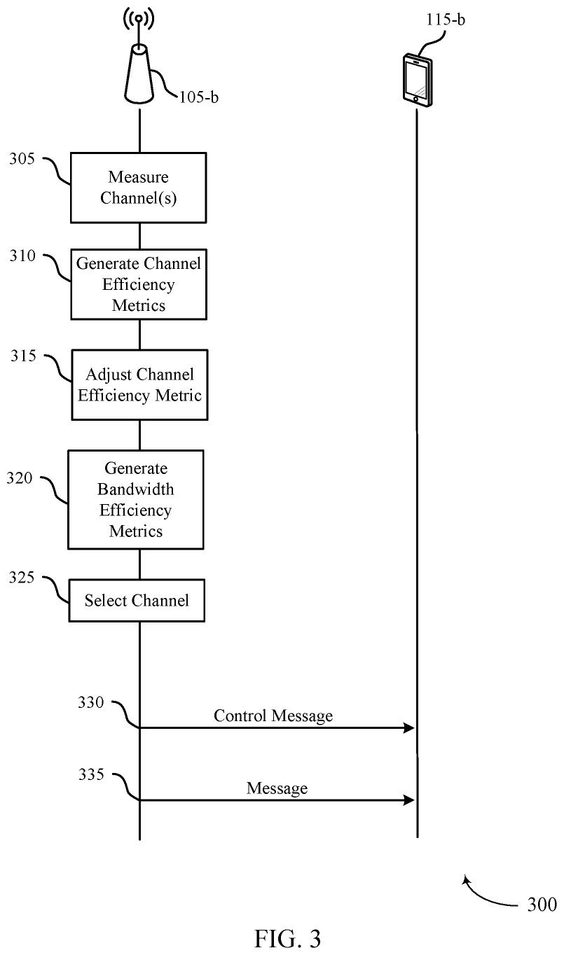

FIG. 3 illustrates an example of a process flow 300 that supports techniques for channel selection in accordance with one or more aspects of the present disclosure. The process flow 300 may implement one or more aspects of the WLAN 100 and the flowchart 200. For example, at 310, the AP 105-b may generate channel efficiency metrics, which may be examples of “metrics for each channel” as described with reference to FIG. 2 (e.g., at 215). At 315, the AP 105-b may adjust a channel efficiency metric. In some cases, the AP 105-b may adjust the channel efficiency metric as part of one or more metric calculations as described with reference to FIG. 2 (e.g., at 215). At 320, the AP 105-b may generate bandwidth efficiency metrics (e.g., as part of one or more metric calculations as described with reference to FIG. 2 (e.g., at 215). In some cases, the AP 105-b may, at 325, select a channel, which may be an example of selecting a channel (e.g., based on channel efficiency) as described with reference to FIG. 2 (e.g., at 255).

The process flow 300 may include an AP 105-b and an STA 115-b, which may be examples of APs 105 and STAs 115, as described with reference to FIG. 1. In the following description of process flow 300, the operations between the AP 105-b and the STA 115-b may be transmitted in a different order than the order shown, or the operations may be performed at different times. Some operations may also be left out of process flow 300, or other operations may be added to process flow 300. While the AP 105-b is shown performing a number of the operations of process flow 300, any wireless device may perform the operations shown. For example, the STA 115-b may perform the operations shown.

At 305, the AP 105-b may measure one or more channels of a set of channels. In some cases, the AP 105-b may measure one or more reference signals to determine one or more parameters for a channel. For example, the AP 105-b may receive a reference signal from the STA 115-b (not shown) and may determine a signal quality or a power associated with the reference signal. In some cases, the AP 105-b may determine a channel quality or any other parameter (e.g., measure the channel) based on the reference signal (e.g., measuring the reference signal). Additionally, or alternatively, one or more metrics (e.g., channel efficiency metrics, bandwidth efficiency metrics) may be based on measuring the one or more channels.

At 310, the AP 105-b may generate multiple channel efficiency metrics for multiple channels. In some cases, the AP 105-b may select a channel from a set of channels (e.g., a set of ten different 160 MHz channels, a set of ten different 320 MHz channels, or any other set of channels). As described herein, the term “set” may be used interchangeable with the phrase “one or more.” For example, a set may include one or more items. Accordingly, the AP 105-b may generate a set of respective channel efficiency metrics for each channel of the set of channels (e.g., for each 160 MHz channel, for each 320 MHz channel). The multiple channel efficiency metrics may be based on measuring the multiple channels and based on one or more subchannel puncturing patterns for one or more channels of the multiple channels. For example, a channel efficiency metric may be based on a throughput for a channel and the throughput for the channel may be based on a subchannel puncturing pattern for the channel. In some cases, puncturing a channel may change a throughput of a channel. A subchannel puncturing pattern may indicate one or more portions of channel that are punctured. For example, a subchannel puncturing pattern may be described (e.g., defined) using a puncture bitmap, where each bit of the puncture bitmap corresponds to a subchannel of a channel. In such cases, a bit that is set to a value of “0” may indicate that a respective subchannel is punctured and a bit that is set to a value of “1” may indicate that a respective subchannel is not punctured, or vice versa. As an illustrative example, a puncture bitmap of P1111101 may indicate that a seventh 20 MHz subchannel of eight 20 MHz subchannels is punctured. Additionally, or alternatively, the character “P” may indicate which subchannel is a primary subchannel.

In some cases, the AP 105-b may generate a channel efficiency metric for a channel based on a throughput for the channel and a quantity of basic service sets within a range of the AP 105-b. Some illustrative examples of channel efficiency calculations used to generate the channel efficiency metric are provided by Equations 1-4, which are described in further detail with reference to FIG. 1. In some cases, the AP 105-b may measure (e.g., generate, determine) multiple channel metrics including a noise floor metric, a received signal strength indicator, a quantity of overlapping basic service sets, a spatial reuse parameter, a channel utilization, a throughput, and a transmit power. The multiple channel efficiency metrics may be based on the multiple channel metrics.

At 315, the AP 105-b may adjust a channel efficiency metric for a channel of the multiple channels based on a quantity of subchannels of the channel that are punctured according to a subchannel puncturing pattern. The channel efficiency metric may be adjusted by reducing the channel efficiency metric based on the quantity of punctured subchannels of the channel (e.g., proportionally decrease channel efficiency as per puncturing). For example, the channel efficiency metric may be based on a throughput of the channel, which may be punctured. The AP 105-b may reduce the channel efficiency metric to reflect that a throughput of the channel is reduced by puncturing the channel. For example, the AP 105-b may determine a first channel efficiency metric based on a first channel, which may not be punctured. The AP 105-b may determine a second channel efficiency metric based on reducing the first channel efficiency metric by a quantity. For example, the AP 105-b may reduce the first channel efficiency metric by a quantity that is proportional to a percentage of a channel that is punctured. That is, a relatively high percentage of a channel being puncturing may correspond to a relatively high reduction of the first channel efficiency metric. Additionally, or alternatively, reducing the channel efficiency metric may be based on reducing a channel grade for a punctured channel. For example, an 80 MHz channel may have a grade of 100 and a 60 MHz channel (e.g., 20 MHz of the 80 MHz channel is punctured) may have a grade of 75.

At 320, the AP 105-b may generate (e.g., measure, determine) multiple bandwidth efficiency metrics for the multiple channels. In some cases, the AP 105-b may select the channel of the multiple channels based on a generated bandwidth efficiency metric for the channel satisfying a threshold. In some cases, the AP 105-b may generate (e.g., measure, determine) the multiple bandwidth efficiency metrics based on multiple probabilities that respective subchannels of the multiple channels are occupied and based on whether one or more respective subchannels of the multiple channels are punctured. In some cases, the generated bandwidth efficiency metric may be a function of multiple probabilities of multiple subchannels of the channel being available. In some cases, the multiple bandwidth efficiency metrics may be based on respective throughputs for each channel of the multiple channels. Additionally, or alternatively, the multiple bandwidth efficiency metrics may be based on a type of the AP 105-b or a type of protocol for operations at the AP 105-b. For example, the bandwidth efficiency metric may be based on whether the AP 105-b operates according to an IEEE 802.11be OFDMA protocol (e.g., standard), an IEEE 802.11be non-OFDMA protocol, a legacy protocol, or any other protocol. Some illustrative examples of bandwidth efficiency calculations are provided by Equations 5-9, which are described in further detail with reference to FIG. 1.

At 325, the AP 105-b may select the channel from the multiple channels based on a comparison of the channel efficiency metric for the channel relative to channel efficiency metrics for other channels of the multiple channels. In some cases, the AP 105-b selecting the channel (e.g., at 325) may be an example of selecting the channel as described with reference to FIG. 2 (e.g., at 255). In some cases, the AP 105-b may select the channel from the multiple channels based on the channel efficiency metric for the channel satisfying a threshold (e.g., being greater than a threshold channel efficiency metric). The AP 105-b may select the channel from the multiple channels based on a first bandwidth efficiency metric for the channel satisfying a threshold (e.g., being greater than a threshold bandwidth efficiency metric). In some cases, the first bandwidth efficiency metric is a function of (e.g., based on) multiple probabilities of multiple subchannels of the channel being available.

At 330, the AP 105-b may transmit a control message including a puncture bitmap that indicates a subchannel puncturing pattern for one or more subchannels of the channel. In some cases, the message is transmitted on the channel in accordance with the puncture bitmap. For example, the channel may be punctured according to the puncture bitmap. Additionally, or alternatively, the AP 105-b may monitor for the control message based on the puncture bitmap. For example, the AP 105-b may monitor the channel that is punctured according to the puncture bitmap. The AP 105-b may receive the control message based on monitoring the punctured channel according to the puncture bitmap. In some cases, each bit of the puncture bitmap corresponds to a subchannel of a channel. In such cases, a bit that is set to a value of “0” may indicate that a respective subchannel is punctured and a bit that is set to a value of “1” may indicate that a respective subchannel is not punctured, or vice versa. As an illustrative example, a puncture bitmap of P1111101 may indicate that a seventh 20 MHz subchannel of eight 20 MHz subchannels is punctured. Additionally, or alternatively, the character “P” may indicate which subchannel is a primary subchannel.

At 335, the AP 105-b may transmit a message on a channel of the multiple channels based on a channel efficiency metric, of the multiple channel efficiency metrics, for the channel. In some cases, the channel efficiency metric is a function of a bandwidth of the channel, a throughput for the channel, a quantity of overlapping basic service sets within a proximity of the AP, and one or more weighting factors corresponding to respective types of clients. As an illustrative example, a type of client may be an IEEE 802.11be OFDM client, an IEEE 802.11be non-OFDMA client, a legacy client, or the like. In some cases, the channel efficiency metric may be based on a frequency location of a punctured subchannel within a bandwidth of the channel.

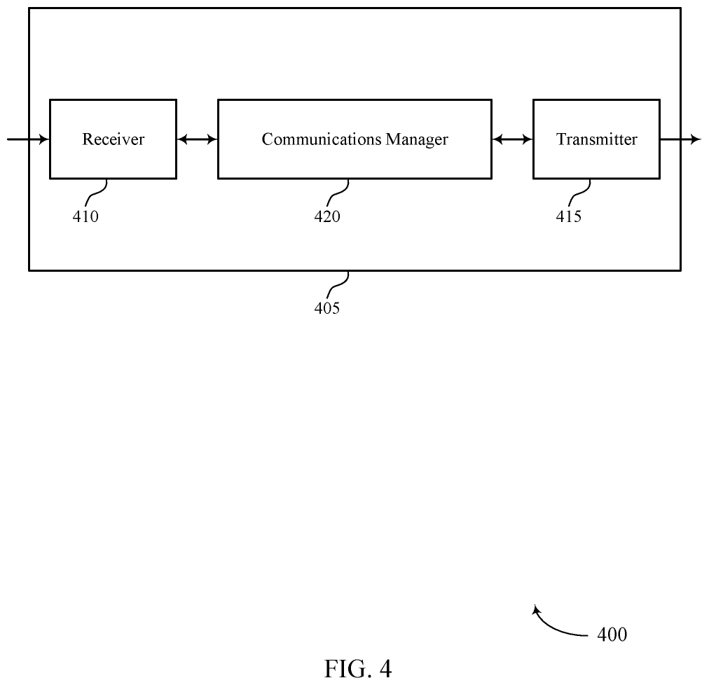

FIG. 4 shows a block diagram 400 of a device 405 that supports techniques for channel selection in accordance with one or more aspects of the present disclosure. The device 405 may be an example of aspects of an AP as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for channel selection). Information may be passed on to other components of the device 405. The receiver 410 may utilize a single antenna or a set of multiple antennas.

The transmitter 415 may provide a means for transmitting signals generated by other components of the device 405. The transmitter 415 may utilize a single antenna or a set of multiple antennas.

The communications manager 420, the receiver 410, the transmitter 415, or various combinations thereof or various components thereof may be examples of means for performing various aspects of techniques for channel selection as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at an AP in accordance with examples as disclosed herein. For example, the communications manager 420 may be configured as or otherwise support a means for generating a set of multiple channel efficiency metrics for a set of multiple channels, where the set of multiple channel efficiency metrics are based on measuring the set of multiple channels and one or more subchannel puncturing patterns for one or more channels of the set of multiple channels. The communications manager 420 may be configured as or otherwise support a means for transmitting a message on a channel of the set of multiple channels based on a channel efficiency metric, of the set of multiple channel efficiency metrics, for the channel.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for performing channel selection procedures that account for one or more sub-channels of a particular channel being punctured. For example, the device 405 may generate multiple channel efficiency metrics for multiple channels. The multiple channel efficiency metrics may be based on measuring the multiple channels and one or more subchannel puncturing patterns for the one or more channels of the multiple channels. Basing the multiple channel efficiency metrics on the one or more subchannel puncturing patterns may result in more efficient utilization of communication resources. For example, the device 405 may refrain from measuring punctured portions of channels. Additionally, or alternatively, the device 405 may select more efficient channels (e.g., punctured channels) for communications, which may result in more efficient utilization of communication resources. In some cases, the device 405 may perform a channel selection procedure that provides one or more potential advantages when compared to conventional channel selection procedures, such as reducing a complexity of selecting one or more channels (e.g., as a result of reduced computational complexity). Additionally, or alternatively, the channel selection procedure as described herein may reduce processing overhead, which may enable some lower cost devices (e.g., with reduced processing capabilities when compared to conventional devices) to effectively perform the channel selection procedure.

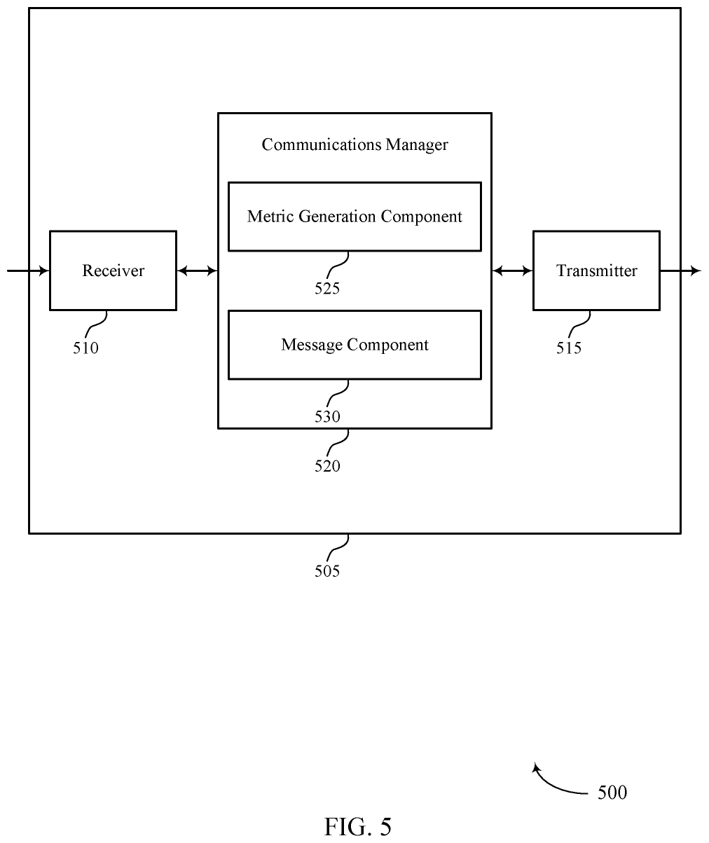

FIG. 5 shows a block diagram 500 of a device 505 that supports techniques for channel selection in accordance with one or more aspects of the present disclosure. The device 505 may be an example of aspects of a device 405 or an AP 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for channel selection). Information may be passed on to other components of the device 505. The receiver 510 may utilize a single antenna or a set of multiple antennas.

The transmitter 515 may provide a means for transmitting signals generated by other components of the device 505. The transmitter 515 may utilize a single antenna or a set of multiple antennas.

The device 505, or various components thereof, may be an example of means for performing various aspects of techniques for channel selection as described herein. For example, the communications manager 520 may include a metric generation component 525 a message component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at an AP in accordance with examples as disclosed herein. The metric generation component 525 may be configured as or otherwise support a means for generating a set of multiple channel efficiency metrics for a set of multiple channels, where the set of multiple channel efficiency metrics are based on measuring the set of multiple channels and one or more subchannel puncturing patterns for one or more channels of the set of multiple channels. The message component 530 may be configured as or otherwise support a means for transmitting a message on a channel of the set of multiple channels based on a channel efficiency metric, of the set of multiple channel efficiency metrics, for the channel.

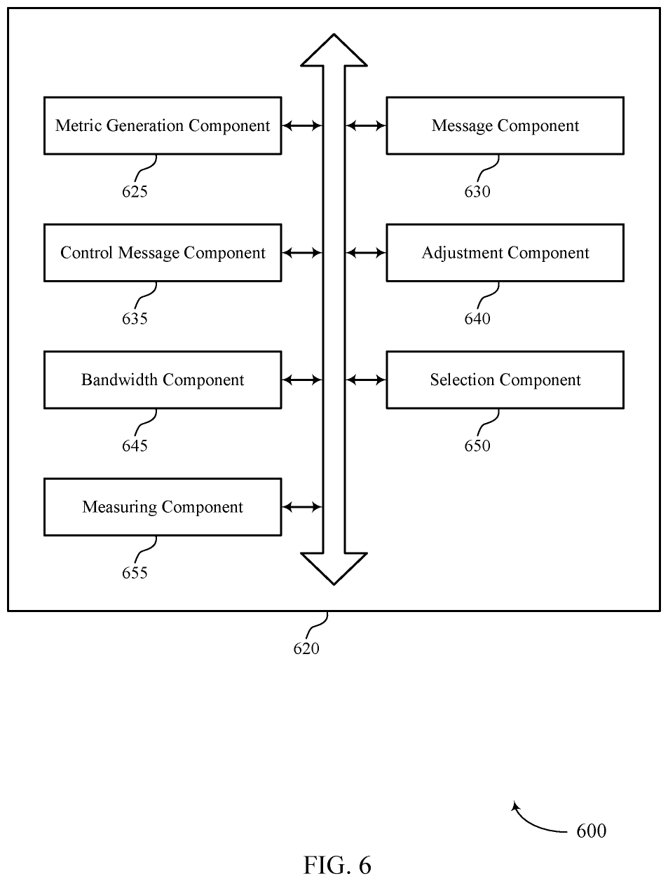

FIG. 6 shows a block diagram 600 of a communications manager 620 that supports techniques for channel selection in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for channel selection as described herein. For example, the communications manager 620 may include a metric generation component 625, a message component 630, a control message component 635, an adjustment component 640, a bandwidth component 645, a selection component 650, a measuring component 655, or any combination thereof. Each of these components may communicate, directly or indirectly, with one another (e.g., via one or more buses).

The communications manager 620 may support wireless communication at an AP in accordance with examples as disclosed herein. The metric generation component 625 may be configured as or otherwise support a means for generating a set of multiple channel efficiency metrics for a set of multiple channels, where the set of multiple channel efficiency metrics are based on measuring the set of multiple channels and one or more subchannel puncturing patterns for one or more channels of the set of multiple channels. The message component 630 may be configured as or otherwise support a means for transmitting a message on a channel of the set of multiple channels based on a channel efficiency metric, of the set of multiple channel efficiency metrics, for the channel.

In some examples, the control message component 635 may be configured as or otherwise support a means for transmitting a control message including a puncture bitmap that indicates a subchannel puncturing pattern for one or more subchannels of the channel, where the message is transmitted on the channel in accordance with the puncture bitmap.

In some examples, the adjustment component 640 may be configured as or otherwise support a means for adjusting the channel efficiency metric for the channel of the set of multiple channels based on a quantity of subchannels of the channel that are punctured according to a subchannel puncturing pattern.

In some examples, the channel efficiency metric is adjusted by reducing the channel efficiency metric based on the quantity of punctured subchannels of the channel.

In some examples, the bandwidth component 645 may be configured as or otherwise support a means for generating a set of multiple bandwidth efficiency metrics for the set of multiple channels, and select the channel of the plurality of channels based at least in part on the plurality of bandwidth efficiency metrics.

In some examples, the bandwidth component 645 may be configured as or otherwise support a means for generating a bandwidth efficiency metric of the set of multiple bandwidth efficiency metrics for the channel based on a set of multiple probabilities that respective subchannels of the channel are occupied and based on whether one or more respective subchannels of the channel are punctured.

In some examples, the generated bandwidth efficiency metric is a function of a set of multiple probabilities of a set of multiple subchannels of the channel being available.

In some examples, to support generating the set of multiple channel efficiency metrics, the metric generation component 625 may be configured as or otherwise support a means for generating the channel efficiency metric for the channel based on a throughput associated with the channel and a quantity of basic service sets within a range of the AP.

In some examples, the selection component 650 may be configured as or otherwise support a means for selecting the channel from the set of multiple channels based on a comparison of the channel efficiency metric for the channel relative to channel efficiency metrics for other channels of the set of multiple channels.

In some examples, the selection component 650 may be configured as or otherwise support a means for selecting the channel from the set of multiple channels based on the channel efficiency metric for the channel satisfying a threshold.

In some examples, the measuring component 655 may be configured as or otherwise support a means for measuring a set of multiple channel metrics including a noise floor metric, a received signal strength indicator, a quantity of overlapping basic service sets, a spatial reuse parameter, a channel utilization, a throughput, and a transmit power, where the set of multiple channel efficiency metrics are based on the set of multiple channel metrics.

In some examples, the channel efficiency metric is a function of a bandwidth of the channel, a throughput for the channel, a quantity of overlapping basic service sets within a proximity of the AP, and one or more weighting factors corresponding to respective types of clients.

In some examples, the channel efficiency metric is based on a frequency location of a punctured subchannel within a bandwidth of the channel.

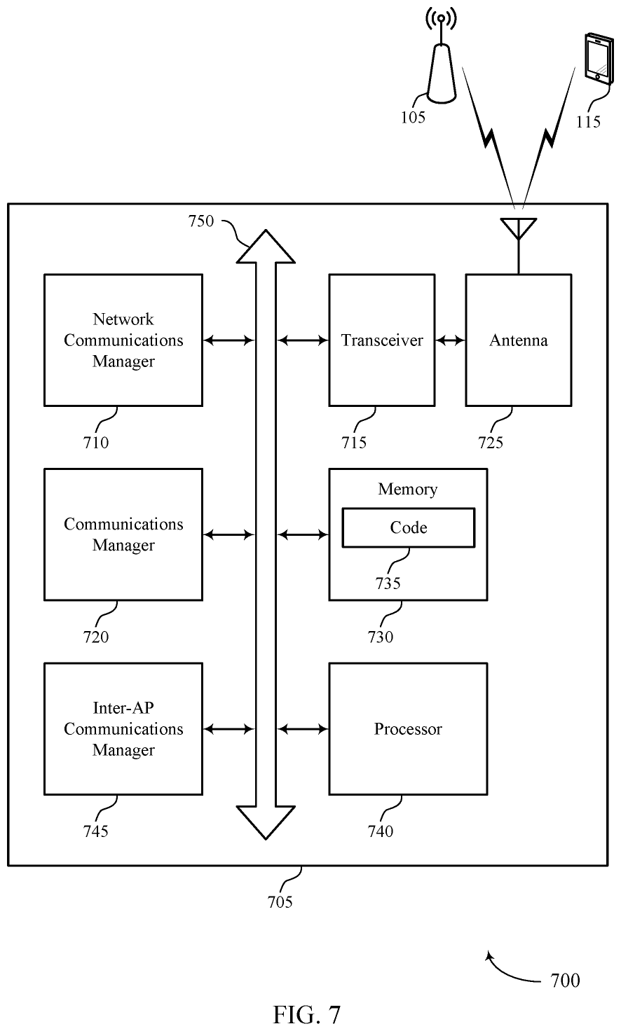

FIG. 7 shows a diagram of a system 700 including a device 705 that supports techniques for channel selection in accordance with one or more aspects of the present disclosure. The device 705 may be an example of or include the components of a device 405, a device 505, or an AP as described herein. The device 705 may include components for bi-directional voice and data communications including components for transmitting and receiving communications, such as a communications manager 720, a network communications manager 710, a transceiver 715, an antenna 725, a memory 730, code 735, a processor 740, and an inter-AP communications manager 745. These components may be in electronic communication or otherwise coupled (e.g., operatively, communicatively, functionally, electronically, electrically) via one or more buses (e.g., a bus 750).

The network communications manager 710 may manage communications with a core network (e.g., via one or more wired backhaul links). For example, the network communications manager 710 may manage the transfer of data communications for client devices, such as one or more STAs 115.

In some cases, the device 705 may include a single antenna 725. However, in some other cases the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets and provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include RAM and ROM. The memory 730 may store computer-readable, computer-executable code 735 including instructions that, when executed by the processor 740, cause the device 705 to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for channel selection). For example, the device 705 or a component of the device 705 may include a processor 740 and memory 730 coupled with or to the processor 740, the processor 740 and memory 730 configured to perform various functions described herein.

The inter-station communications manager 745 may manage communications with other APs 105, and may include a controller or scheduler for controlling communications with STAs 115 in cooperation with other APs 105. For example, the inter-station communications manager 745 may coordinate scheduling for transmissions to APs 105 for various interference mitigation techniques such as beamforming or joint transmission. In some examples, the inter-station communications manager 745 may provide an X2 interface within an LTE/LTE-A wireless communication network technology to provide communication between APs 105.

The communications manager 720 may support wireless communication at an AP in accordance with examples as disclosed herein. For example, the communications manager 720 may be configured as or otherwise support a means for generating a set of multiple channel efficiency metrics for a set of multiple channels, where the set of multiple channel efficiency metrics are based on measuring the set of multiple channels and one or more subchannel puncturing patterns for one or more channels of the set of multiple channels. The communications manager 720 may be configured as or otherwise support a means for transmitting a message on a channel of the set of multiple channels based on a channel efficiency metric, of the set of multiple channel efficiency metrics, for the channel.

By including or configuring the communications manager 720 in accordance with examples as described herein, the device 705 may support techniques for performing channel selection procedures that account for one or more sub-channels of a particular channel being punctured. For example, the device 705 may generate multiple channel efficiency metrics for multiple channels. The multiple channel efficiency metrics may be based on measuring the multiple channels and one or more subchannel puncturing patterns for the one or more channels of the multiple channels. Basing the multiple channel efficiency metrics on the one or more subchannel puncturing patterns may result in, improved communication reliability and more efficient utilization of communication resources. For example, the device 705 may select a channel for communications (e.g., a punctured channel) based on one or more channel metrics that accurately account for channel puncturing. In some cases, the device 705 may perform a channel selection procedure that provides one or more potential advantages when compared to conventional channel selection procedures, such as reducing a complexity of selecting one or more channels (e.g., as a result of reduced computational complexity). Additionally, or alternatively, the channel selection procedure as described herein may reduce processing overhead, which may enable some lower cost devices (e.g., with reduced processing capabilities when compared to conventional devices) to effectively perform the channel selection procedure.

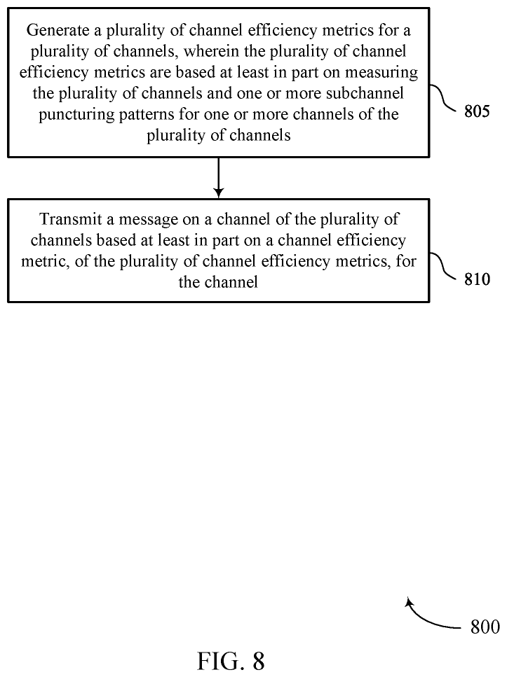

FIG. 8 shows a flowchart illustrating a method 800 that supports techniques for channel selection in accordance with one or more aspects of the present disclosure. The operations of the method 800 may be implemented by an AP or its components as described herein. For example, the operations of the method 800 may be performed by an AP as described with reference to FIGS. 1 through 7. In some examples, an AP may execute a set of instructions to control the functional elements of the AP to perform the described functions. Additionally, or alternatively, the AP may perform aspects of the described functions using special-purpose hardware.

At 805, the method may include generating a set of multiple channel efficiency metrics for a set of multiple channels, where the set of multiple channel efficiency metrics are based on measuring the set of multiple channels and one or more subchannel puncturing patterns for one or more channels of the set of multiple channels. The operations of 805 may be performed in accordance with examples as disclosed herein. In some examples, aspects of the operations of 805 may be performed by a metric generation component 625 as described with reference to FIG. 6.

At 810, the method may include transmitting a message on a channel of the set of multiple channels based on a channel efficiency metric, of the set of multiple channel efficiency metrics, for the channel. The operations of 810 may be performed in accordance with examples as disclosed herein. In some examples, aspects of the operations of 810 may be performed by a message component 630 as described with reference to FIG. 6.

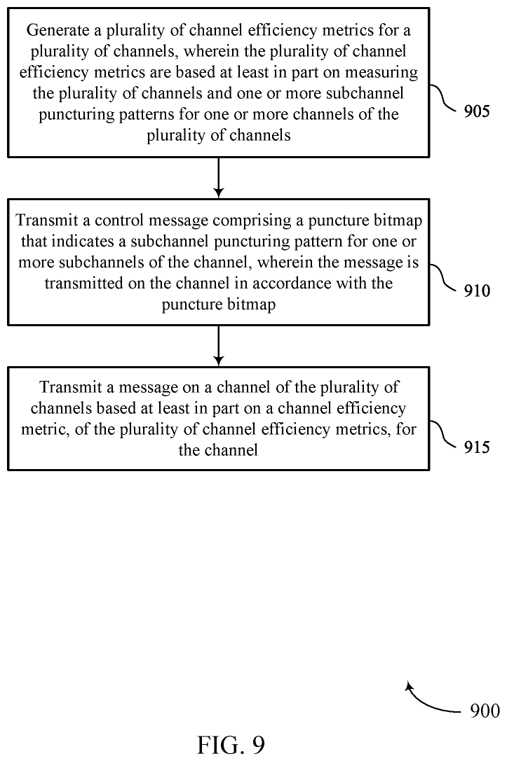

FIG. 9 shows a flowchart illustrating a method 900 that supports techniques for channel selection in accordance with one or more aspects of the present disclosure. The operations of the method 900 may be implemented by an AP or its components as described herein. For example, the operations of the method 900 may be performed by an AP as described with reference to FIGS. 1 through 7. In some examples, an AP may execute a set of instructions to control the functional elements of the AP to perform the described functions. Additionally, or alternatively, the AP may perform aspects of the described functions using special-purpose hardware.

At 905, the method may include generating a set of multiple channel efficiency metrics for a set of multiple channels, where the set of multiple channel efficiency metrics are based on measuring the set of multiple channels and one or more subchannel puncturing patterns for one or more channels of the set of multiple channels. The operations of 905 may be performed in accordance with examples as disclosed herein. In some examples, aspects of the operations of 905 may be performed by a metric generation component 625 as described with reference to FIG. 6.

At 910, the method may include transmitting a control message including a puncture bitmap that indicates a subchannel puncturing pattern for one or more subchannels of the channel, where the message is transmitted on the channel in accordance with the puncture bitmap. The operations of 910 may be performed in accordance with examples as disclosed herein. In some examples, aspects of the operations of 910 may be performed by a control message component 635 as described with reference to FIG. 6.

At 915, the method may include transmitting a message on a channel of the set of multiple channels based on a channel efficiency metric, of the set of multiple channel efficiency metrics, for the channel. The operations of 915 may be performed in accordance with examples as disclosed herein. In some examples, aspects of the operations of 915 may be performed by a message component 630 as described with reference to FIG. 6. The following provides an overview of aspects of the present disclosure:

Aspect 1: A method for wireless communication at an AP, comprising: generating a plurality of channel efficiency metrics for a plurality of channels, wherein the plurality of channel efficiency metrics are based at least in part on measuring the plurality of channels and one or more subchannel puncturing patterns for one or more channels of the plurality of channels; and transmitting a message on a channel of the plurality of channels based at least in part on a channel efficiency metric, of the plurality of channel efficiency metrics, for the channel.

Aspect 2: The method of aspect 1, further comprising: transmitting a control message comprising a puncture bitmap that indicates a subchannel puncturing pattern for one or more subchannels of the channel, wherein the message is transmitted on the channel in accordance with the puncture bitmap.

Aspect 3: The method of any of aspects 1 through 2, further comprising: adjusting the channel efficiency metric for the channel of the plurality of channels based at least in part on a quantity of subchannels of the channel that are punctured according to a subchannel puncturing pattern.

Aspect 4: The method of aspect 3, wherein the channel efficiency metric is adjusted by reducing the channel efficiency metric based at least in part on the quantity of punctured subchannels of the channel.

Aspect 5: The method of any of aspects 1 through 4, further comprising: selecting the channel of the plurality of channels based at least in part on a plurality of bandwidth efficiency metrics for the plurality of channels.

Aspect 6: The method of aspect 5, wherein a bandwidth efficiency metric, of the plurality of bandwidth efficiency metrics, for the channel is based at least in part on a plurality of probabilities that respective subchannels of the channel are occupied and based at least in part on whether one or more respective subchannels of the channel are punctured.

Aspect 7: The method of any of aspects 5 through 6, wherein the bandwidth efficiency metric is a function of a plurality of probabilities of a plurality of subchannels of the channel being available.

Aspect 8: The method of any of aspects 1 through 7, wherein generating the plurality of channel efficiency metrics further comprises: generating the channel efficiency metric for the channel based at least in part on a throughput associated with the channel and a quantity of basic service sets within a range of the AP.

Aspect 9: The method of any of aspects 1 through 8, further comprising: selecting the channel from the plurality of channels based at least in part on a comparison of the channel efficiency metric for the channel relative to channel efficiency metrics for other channels of the plurality of channels.

Aspect 10: The method of any of aspects 1 through 9, further comprising: selecting the channel from the plurality of channels based at least in part on the channel efficiency metric for the channel satisfying a threshold.

Aspect 11: The method of any of aspects 1 through 10, further comprising: measuring a plurality of channel metrics comprising a noise floor metric, a received signal strength indicator, a quantity of overlapping basic service sets, a spatial reuse parameter, a channel utilization, a throughput, and a transmit power, wherein the plurality of channel efficiency metrics are based at least in part on the plurality of channel metrics.

Aspect 12: The method of any of aspects 1 through 11, wherein the channel efficiency metric is a function of a bandwidth of the channel, a throughput for the channel, a quantity of overlapping basic service sets within a proximity of the AP, and one or more weighting factors corresponding to respective types of clients.

Aspect 13: The method of any of aspects 1 through 12, wherein the channel efficiency metric is based at least in part on a frequency location of a punctured subchannel within a bandwidth of the channel.

Aspect 14: An apparatus for wireless communication at an AP, comprising a processor; memory coupled with the processor; and instructions stored in the memory and executable by the processor to cause the apparatus to perform a method of any of aspects 1 through 13.

Aspect 15: An apparatus for wireless communication at an AP, comprising at least one means for performing a method of any of aspects 1 through 13.

Aspect 16: A non-transitory computer-readable medium storing code for wireless communication at an AP, the code comprising instructions executable by a processor to perform a method of any of aspects 1 through 13.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), OFDMA, single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, in the WLAN 100 of FIGS. 1—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication at an access point (AP), comprising:
a processor;
memory coupled with the processor; and
instructions stored in the memory and executable by the processor to cause the apparatus to:
generate a plurality of channel efficiency metrics for a plurality of channels, wherein the plurality of channel efficiency metrics are based at least in part on measuring the plurality of channels and one or more subchannel puncturing patterns for one or more channels of the plurality of channels; and
transmit a message on a channel of the plurality of channels based at least in part on a channel efficiency metric, of the plurality of channel efficiency metrics, for the channel.

2. The apparatus of claim 1, wherein the instructions are further executable by the processor to cause the apparatus to:
transmit a control message comprising a puncture bitmap that indicates a subchannel puncturing pattern for one or more subchannels of the channel, wherein the message is transmitted on the channel in accordance with the puncture bitmap.

3. The apparatus of claim 1, wherein the instructions are further executable by the processor to cause the apparatus to:
adjust the channel efficiency metric for the channel of the plurality of channels based at least in part on a quantity of subchannels of the channel that are punctured according to a subchannel puncturing pattern.

4. The apparatus of claim 3, wherein the channel efficiency metric is adjusted by reducing the channel efficiency metric based at least in part on the quantity of punctured subchannels of the channel.

5. The apparatus of claim 1, wherein the instructions are further executable by the processor to cause the apparatus to:
select the channel of the plurality of channels based at least in part on a plurality of bandwidth efficiency metrics for the plurality of channels.

6. The apparatus of claim 5, wherein a bandwidth efficiency metric, of the plurality of bandwidth efficiency metrics, for the channel is based at least in part on a plurality of probabilities that respective subchannels of the channel are occupied and based at least in part on whether one or more respective subchannels of the channel are punctured.

7. The apparatus of claim 6, wherein the bandwidth efficiency metric is a function of a plurality of probabilities of a plurality of subchannels of the channel being available.

8. The apparatus of claim 1, wherein the instructions to generate the plurality of channel efficiency metrics are further executable by the processor to cause the apparatus to:
generate the channel efficiency metric for the channel based at least in part on a throughput associated with the channel and a quantity of basic service sets within a range of the AP.

9. The apparatus of claim 1, wherein the instructions are further executable by the processor to cause the apparatus to:
select the channel from the plurality of channels based at least in part on a comparison of the channel efficiency metric for the channel relative to channel efficiency metrics for other channels of the plurality of channels.

10. The apparatus of claim 1, wherein the instructions are further executable by the processor to cause the apparatus to:
select the channel from the plurality of channels based at least in part on the channel efficiency metric for the channel satisfying a threshold.

11. The apparatus of claim 1, wherein the instructions are further executable by the processor to cause the apparatus to:
measure a plurality of channel metrics comprising a noise floor metric, a received signal strength indicator, a quantity of overlapping basic service sets, a spatial reuse parameter, a channel utilization, a throughput, and a transmit power, wherein the plurality of channel efficiency metrics are based at least in part on the plurality of channel metrics.

12. The apparatus of claim 1, wherein the channel efficiency metric is a function of a bandwidth of the channel, a throughput for the channel, a quantity of overlapping basic service sets within a proximity of the AP, and one or more weighting factors corresponding to respective types of clients.

13. The apparatus of claim 1, wherein the channel efficiency metric is based at least in part on a frequency location of a punctured subchannel within a bandwidth of the channel.

14. A method for wireless communication at an access point (AP), comprising:
generating a plurality of channel efficiency metrics for a plurality of channels, wherein the plurality of channel efficiency metrics are based at least in part on measuring the plurality of channels and one or more subchannel puncturing patterns for one or more channels of the plurality of channels; and
transmitting a message on a channel of the plurality of channels based at least in part on a channel efficiency metric, of the plurality of channel efficiency metrics, for the channel.

15. The method of claim 14, further comprising:
transmitting a control message comprising a puncture bitmap that indicates a subchannel puncturing pattern for one or more subchannels of the channel, wherein the message is transmitted on the channel in accordance with the puncture bitmap.

16. The method of claim 14, further comprising:
adjusting the channel efficiency metric for the channel of the plurality of channels based at least in part on a quantity of subchannels of the channel that are punctured according to a subchannel puncturing pattern.

17. The method of claim 16, wherein the channel efficiency metric is adjusted by reducing the channel efficiency metric based at least in part on the quantity of punctured subchannels of the channel.

18. The method of claim 14, further comprising:
selecting the channel of the plurality of channels based at least in part on a plurality of bandwidth efficiency metrics for the plurality of channels.

19. The method of claim 18, wherein a bandwidth efficiency metric, of the plurality of bandwidth efficiency metrics, for the channel is based at least in part on a plurality of probabilities that respective subchannels of the channel are occupied and based at least in part on whether one or more respective subchannels of the channel are punctured.

20. The method of claim 19, wherein the generated bandwidth efficiency metric is a function of a plurality of probabilities of a plurality of subchannels of the channel being available.

21. The method of claim 14, wherein generating the plurality of channel efficiency metrics further comprises:
generating the channel efficiency metric for the channel based at least in part on a throughput associated with the channel and a quantity of basic service sets within a range of the AP.

22. The method of claim 14, further comprising:
selecting the channel from the plurality of channels based at least in part on a comparison of the channel efficiency metric for the channel relative to channel efficiency metrics for other channels of the plurality of channels.

23. The method of claim 14, further comprising:
selecting the channel from the plurality of channels based at least in part on the channel efficiency metric for the channel satisfying a threshold.

24. The method of claim 14, further comprising:
measuring a plurality of channel metrics comprising a noise floor metric, a received signal strength indicator, a quantity of overlapping basic service sets, a spatial reuse parameter, a channel utilization, a throughput, and a transmit power, wherein the plurality of channel efficiency metrics are based at least in part on the plurality of channel metrics.

25. The method of claim 14, wherein the channel efficiency metric is a function of a bandwidth of the channel, a throughput for the channel, a quantity of overlapping basic service sets within a proximity of the AP, and one or more weighting factors corresponding to respective types of clients.

26. The method of claim 14, wherein the channel efficiency metric is based at least in part on a frequency location of a punctured subchannel within a bandwidth of the channel.

27. An apparatus for wireless communication at an access point (AP), comprising:
means for generating a plurality of channel efficiency metrics for a plurality of channels, wherein the plurality of channel efficiency metrics are based at least in part on measuring the plurality of channels and one or more subchannel puncturing patterns for one or more channels of the plurality of channels; and
means for transmitting a message on a channel of the plurality of channels based at least in part on a channel efficiency metric, of the plurality of channel efficiency metrics, for the channel.

28. The apparatus of claim 27, further comprising:
means for transmitting a control message comprising a puncture bitmap that indicates a subchannel puncturing pattern for one or more subchannels of the channel, wherein the message is transmitted on the channel in accordance with the puncture bitmap.

29. The apparatus of claim 27, further comprising:
means for adjusting the channel efficiency metric for the channel of the plurality of channels based at least in part on a quantity of subchannels of the channel that are punctured according to a subchannel puncturing pattern.

30. A non-transitory computer-readable medium storing code for wireless communication at an access point (AP), the code comprising instructions executable by a processor to:
generate a plurality of channel efficiency metrics for a plurality of channels, wherein the plurality of channel efficiency metrics are based at least in part on measuring the plurality of channels and one or more subchannel puncturing patterns for one or more channels of the plurality of channels; and
transmit a message on a channel of the plurality of channels based at least in part on a channel efficiency metric, of the plurality of channel efficiency metrics, for the channel.
